(19) United States
(12) Patent Application Publication
(10) Pub. No.: US 2019/0366771 A1
(43) Pub. Date: Dec. 5, 2019

(54) TIRE WITH INVERSE CASING CONSTRUCTION

(71) Applicant: Specialized Bicycle Components, Inc., Morgan Hill, CA (US)

(72) Inventors: Eva Lutz, Morgan Hill, CA (US); Rüdiger Schulte, Morgan Hill, CA (US); Chun Ming Yeh, Morgan Hill, CA (US)

(21) Appl. No.: 15/991,269

(22) Filed: May 29, 2018

(51) Int. Cl. B60C 7/10; B60B 1/00

(52) U.S. Cl. CPC B60C 7/10; B60B 21/062; B60B 1/003

(57) ABSTRACT

A vehicle tire comprises first and second bead cores spaced apart from each other, a first casing layer wrapped around the bead cores, a second casing layer wrapped around the bead cores, and a tread layer. The first casing layer has first edge sections that overlap with each other at a zenith of the tire and terminate at first edges on opposing sides of the zenith. The second casing layer has second edge sections that do not overlap with each other and that terminate at second edges that are each substantially aligned with one of the first edges. The first and second casing layers are each made of a single unidirectional ply that are in different directions to each other. The sidewall regions and the zenith comprise four plies of casing layers throughout the tire. The tire can further include first and second sidewall reinforcements (e.g., rubber strips) positioned in the first and second sidewall regions.

### BACKGROUND

The present invention relates to tire construction and specifically to a bicycle tire construction having a unique casing construction.

Modern bicycle tires are typically made with multiple casing layers that overlap to create the basic body of the tire. At least one of the casing layers wraps around bead cores on either edge of the tire to define the tire beads. A tread layer is positioned on the casing layers to provide a running surface in contact with the road. A breaker belt can be provided under the tread layer to improve puncture resistance of the tire.

### SUMMARY

The present invention provides a vehicle tire comprising first and second bead cores spaced apart from each other, a first casing layer spanning between the bead cores and wrapped around the bead cores, a second casing layer spanning between the bead cores and wrapped around the bead cores, and a tread layer. The first casing layer has first edge sections that overlap with each other at a zenith of the tire and terminate at first edges on opposing sides of the zenith. The second casing layer has second edge sections that do not overlap with each other and that terminate at second edges that are each substantially aligned with one of the first edges.

In one embodiment, the first and second casing layers are each made of a single unidirectional ply, wherein the ply directions of the two layers are different (e.g., +45 degrees for the first casing layer and −45 degrees for the second casing layer). Preferably, sidewall regions of the tire comprise four plies of casing layers and the zenith comprises four plies of casing layers. In order to enhance sidewall stiffness, the tire can further include first and second sidewall reinforcements (e.g., rubber strips) positioned in the first and second sidewall regions, respectively.

Other aspects of the invention will become apparent by consideration of the detailed description and accompanying drawings.

### BRIEF DESCRIPTION OF THE DRAWINGS

FIG. 1 is a side view of a bicycle having tires embodying the present invention.

FIG. 2 is a flat schematic drawing of a tire construction embodying the present invention.

FIG. 3 is a round schematic drawing of the tire construction in FIG. 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

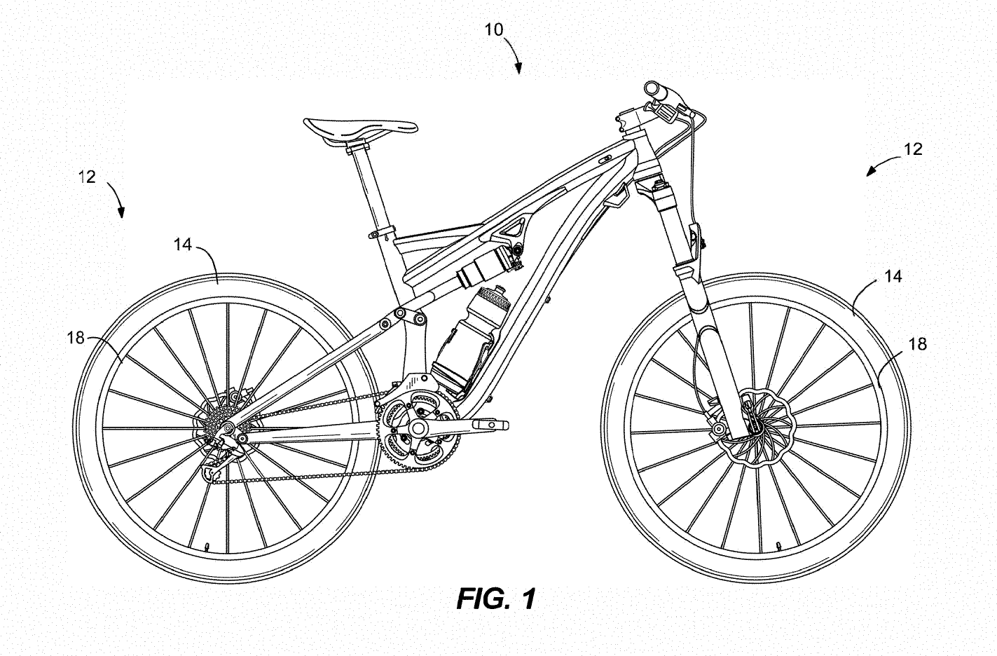

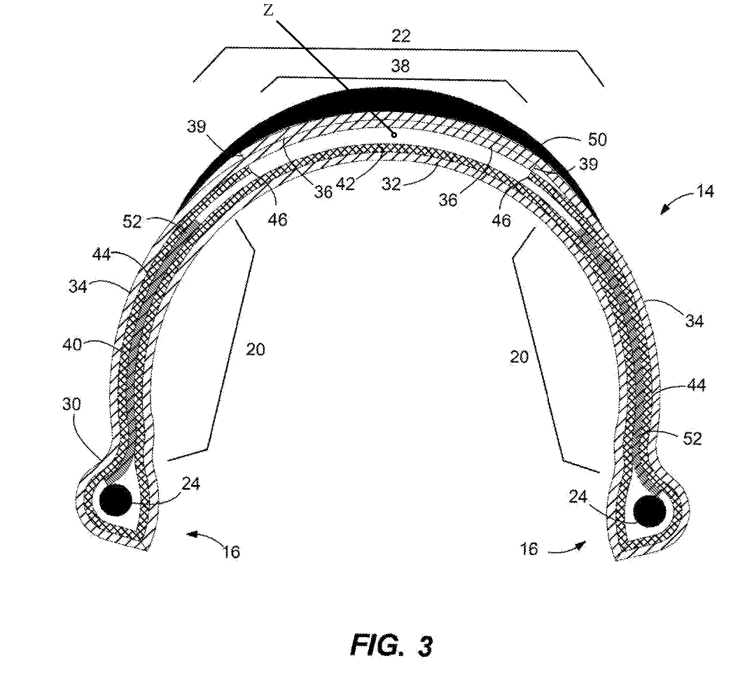

FIG. 1 illustrates a bicycle 10 including wheels 12 with tires 14 embodying the present invention. As with standard tires, the illustrated tires 14 includes typical parts, such as beads 16 (FIG. 3) that are designed to be retained in a wheel rim 18, as is known in the art. Referring to FIG. 3, the beads 16 are coupled to sidewalls 20, which lead to a tread 22. A zenith Z is defined as the center of the tire.

The illustrated tires 14 have a unique layered construction using known materials. For example, the inside of the beads 16 include bead cores 24 made of wire or a polymeric yarn bundle, such as aramid, Kevlar, or Zylon fibers, or a mixed of those materials. The sidewalls 20 are formed by casing layers, described below, that similarly can be made of multiple different known casing materials, such as cloth comprising nylon, cotton or silk. Thread counts can vary, but generally are between 60 and 150 tpi. For airtightness, the casing cloth material can be embedded with rubber or resilient polymer, which is particularly beneficial when using the tire in a tubeless configuration.

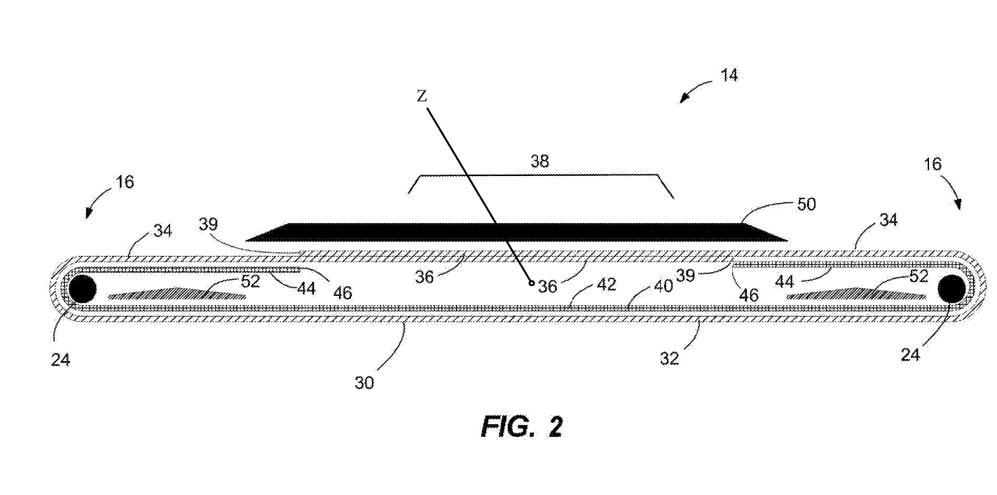

One embodiment of the present invention is represented by the schematic drawings in FIGS. 2-3. The illustrated tire utilizes a first casing layer 30 having a center section 32 that spans between the bead cores 24 and side sections 34 that wrap around the bead cores 24. The side sections 34 of the first casing layer 30 overlap with each other at edge sections 36 in a central tread region 38 of the tire 14, which is generally the region of the tread that contacts the road surface under normal operating conditions. Each edge section 36 of the first casing layer 30 terminates at a first edge 39 offset from the zenith of the tire. The first casing layer 30 is a unidirectional fabric oriented at +45 degrees to the direction of travel.

The illustrated tire also includes a second casing layer 40 having a center section 42 that spans between the bead cores 24 and side sections 44 that wrap around the bead cores 24. The side sections 44 of the second casing layer 40 do not overlap with each other and instead terminate at second edges 46 outside the central tread region 38. The second edges 46 are positioned substantially in alignment with the first edges 39. The second casing layer 40 is a unidirectional fabric oriented at −45 degrees to the direction of travel (i.e., the opposite ply direction as the first casing layer 30).

In the embodiment of FIGS. 2-3, the first casing layer 30 wraps around and encloses the second casing layer 40. However, it should be understood that positioning of the layers could be reversed such that the second casing layer 40 wraps around and encloses the first casing layer 30.

A tread layer 50 is positioned above and spans the central tread region 36 of the tire 14. The illustrated tread layer 50 overlaps the first and second edges 39,46 by about 5-7 mm. The tread layer 50 can be made of any suitable material, such as rubber (synthetic or natural) mixed with carbon black and/or silica, as is known in the art.

The illustrated tire further includes sidewall reinforcements 52 positioned in the sidewalls. The sidewall reinforcements 52 provide added lateral stiffness to the sidewalls, which improves the direct steering impulse and directly transfers lateral forces between the bike and the ground. The illustrated sidewalls reinforcements 52 comprise rubber strips sandwiched in the second casing layer 40 between the center section 42 and the side sections 44, but it should be understood that the rubber strips can instead be positioned between other layers of the sidewall sections. The rubber strips can be made of any suitable material, such as rubber (synthetic or natural) mixed with carbon black and/or silica.

The above-described tire construction provides a tire 14 having four plies of casing layers throughout the complete cross section (i.e., the sidewalls 20 and the central tread region 38). The additional stiffness provided by the sidewall reinforcements results in a tire having stiff sidewalls, for improved steering impulse and control, and a flexible tread area, for improved ground contact area and flexible adaptation to small undulations in the ground surface.

Various features and advantages of the invention are set forth in the following claims.

1. A vehicle tire comprising:
first and second bead cores spaced apart from each other;
a first casing layer spanning between the bead cores and wrapped around the bead cores, the first casing layer having first edge sections that overlap with each other at a zenith of the tire and terminate at first edges on opposing sides of the zenith;
a second casing layer spanning between the bead cores and wrapped around the bead cores, the second casing layer having second edge sections that do not overlap with each other, wherein each second edge section terminates at a second edge that is substantially aligned with one of the first edges; and
a tread layer spanning the zenith.

2. A vehicle tire as claimed in claim 1, wherein the bead cores each include wire or a polymeric yarn bundle comprising aramid fibers or zylon fibers.

3. A vehicle tire as claimed in claim 1, wherein the first casing layer has a unidirectional ply in a first direction and the second casing layer has a unidirectional ply in a second direction different from the first direction.

4. A vehicle tire as claimed in claim 1, wherein the first and second casing layer comprises a unidirectional cloth including nylon, cotton, or silk.

5. A vehicle tire as claimed in claim 1, wherein the tread layer comprises rubber and carbon black.

6. A vehicle tire as claimed in claim 1, wherein first and second sidewall regions are defined between the tread layer and the first and second bead cores, respectively, and wherein the sidewall regions comprise four plies of casing layers and the zenith comprises four plies of casing layers.

7. A vehicle tire as claimed in claim 1, wherein first and second sidewall regions are defined between the tread layer and the first and second bead cores, respectively, and wherein the vehicle tire further includes first and second sidewall reinforcements positioned in the first and second sidewall regions, respectively.

8. A vehicle tire as claimed in claim 7, wherein each of the sidewall reinforcements comprises a rubber strip.
